(19) United States
(12) Patent Application Publication
(10) Pub. No.: US 2012/0207601 A1
(43) Pub. Date: Aug. 16, 2012

(54) Rotor having a Lower Resistance or Drag

(76) Inventor: Yu-Han Wang, Fanlu Township (TW)

(21) Appl. No.: 13/025,236

(22) Filed: Feb. 11, 2011

(51) Int. Cl. F03D 7/02

(52) U.S. Cl. 416/9

(57) ABSTRACT

A rotor for a generating system includes a drive shaft, a plurality of support frames mounted on the drive shaft to rotate the drive shaft, and a plurality of blades each pivotally mounted on a respective one of the support frames. When the power touches the blades, the blades are pushed to pivot such that some of the blades are moved to abut the drive shaft and some of the blades are moved to be parallel with the travel direction of the power. Thus, the blades that are moved to abut the drive shaft will be pushed by the power to rotate the drive shaft, while the blades that are moved to be parallel with the power will not produce a drag or resistance to the power.

### BACKGROUND OF THE INVENTION

1. Field of the Invention

The present invention relates to a blade device and, more particularly, to a rotor for a generating system, such as a wind power or water power generating system.

2. Description of the Related Art

A conventional rotor 12 for a generating system in accordance with the prior art shown in FIGS. 1 and 2 is secured on a drive shaft 11 of a generator 10 to rotate the drive shaft 11 which drives the generating device 30 to provide a generating function. The conventional rotor 12 comprises a plurality of blades 13 which are mounted fixedly. Each of the blades 13 has a first face 131 and a second face 132. Thus, when a power 14, such as the wind power or water power, touches the blades 13, the blades 13 are pushed by the power 14 to rotate the rotor 12 which rotates the drive shaft 11 which drives the generating device 30 so as to provide a generating function. However, when the power 14 pushes the first faces 131 of some of the blades 13 to move the blades 13, the power 14 also pushes the second faces 132 of the other opposite blades 13 to provide a resistance or drag force to the blades 13 so that the driving force of the power 14 is counteracted by the resistance or drag, and the rotation torque and speed of the rotor 12 are reduced largely, thereby greatly decreasing the generating function.

### BRIEF SUMMARY OF THE INVENTION

In accordance with the present invention, there is provided a rotor, comprising a drive shaft, a plurality of support frames mounted on the drive shaft to rotate the drive shaft, and a plurality of blades each pivotally mounted on a respective one of the support frames. Each of the support frames includes two crossbars each connected with the drive shaft to rotate the drive shaft, and an upright support bar mounted between the two crossbars. Each of the blades has a first end pivotally mounted on the respective support frame and a second end that is movable to abut the drive shaft. The first end of each of the blades is pivotally mounted on the upright support bar of the respective support frame. The support frames further includes a limit rod mounted between the two crossbars to limit each of the blades. Each of the blades is movable to abut the limit rod of the respective support frame.

The primary objective of the present invention is to provide a rotor having a lower resistance or drag during rotation.

According to the primary objective of the present invention, the blades are pivotally mounted on the support frames and are pivotable relative to the drive shaft so that when the power touches the blades, the blades are pushed to pivot toward the travel direction of the power such that some of the blades are moved to abut the drive shaft and some of the blades are moved to space from the drive shaft and to be parallel with the travel direction of the power.

According to another objective of the present invention, the blades that are moved to abut the drive shaft will be pushed by the power to drive and rotate the drive shaft so as to drive the generating device to provide a generating function, while the blades that are moved to be parallel with the power are directed toward the travel direction of the power and will not produce a drag or resistance to the power so as to facilitate rotation of the drive shaft and to enhance the generating efficiency.

According to a further objective of the present invention, each of the blades is movable to abut the limit rod of the respective support frame so that each of the blades is supported by the limit rod of the respective support frame solidly and stably.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a conventional rotor for a generating system in accordance with the prior art.

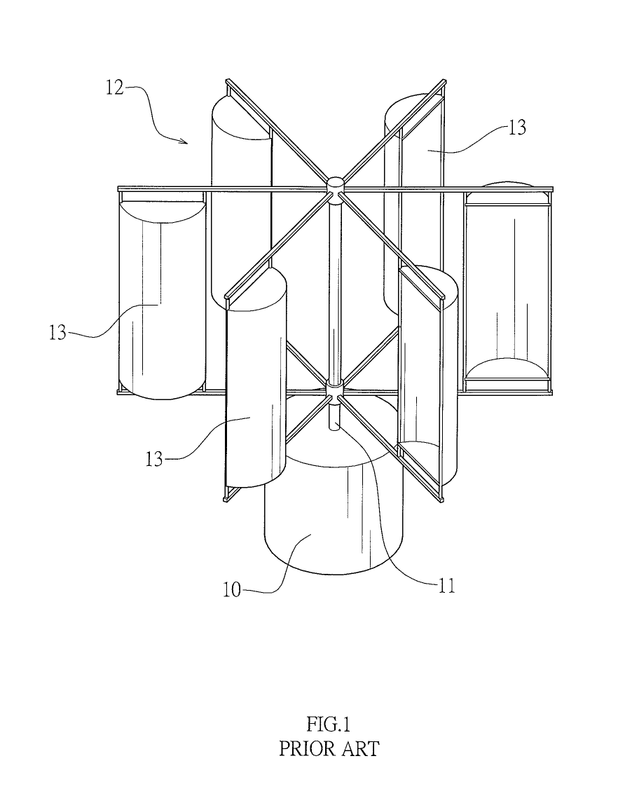

FIG. 2 is a top operational view of the conventional rotor for a generating system as shown in FIG. 1.

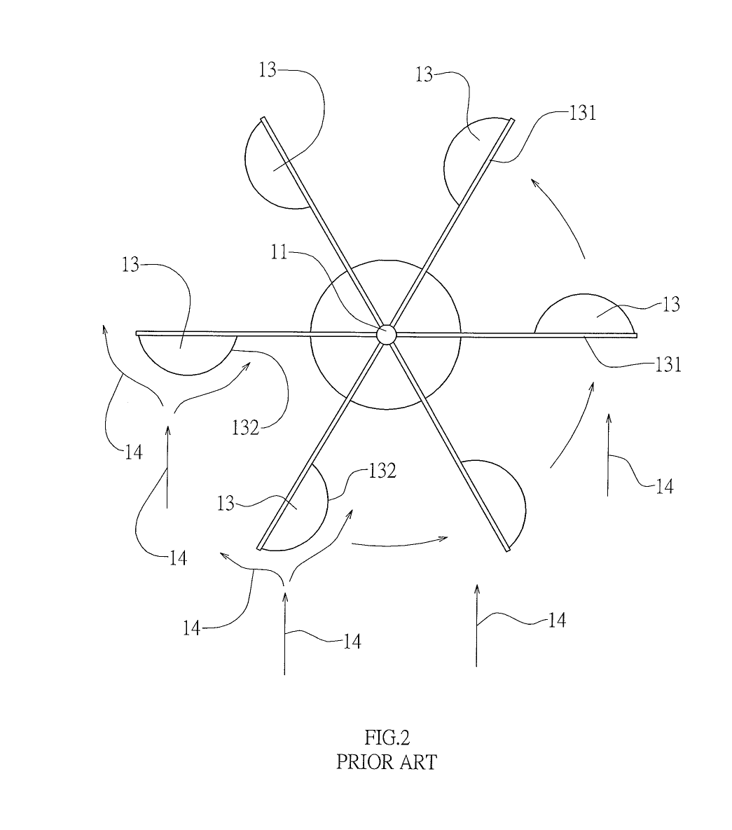

FIG. 3 is a perspective view of a rotor for a generating system in accordance with the preferred embodiment of the present invention.

FIG. 4 is a top cross-sectional operational view of the rotor for a generating system as shown in FIG. 3.

FIG. 5 is a top cross-sectional operational view of the rotor for a generating system as shown in FIG. 3.

FIG. 6 is a perspective view of a rotor for a generating system in accordance with another preferred embodiment of the present invention.

FIG. 7 is a top cross-sectional operational view of the rotor for a generating system as shown in FIG. 6.

### DETAILED DESCRIPTION OF THE INVENTION

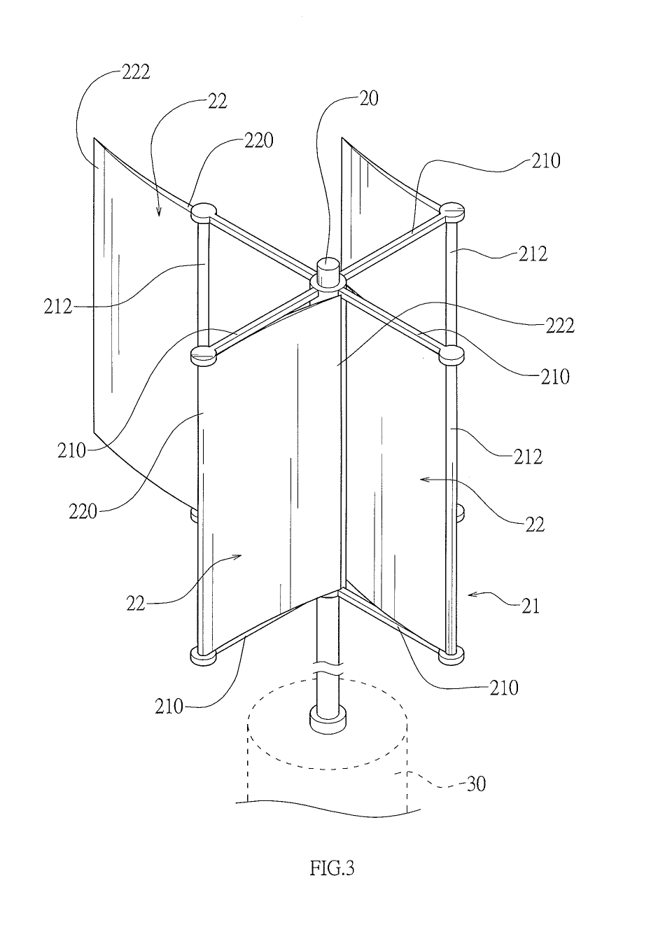

Referring to the drawings and initially to FIG. 3, a rotor for a generating system in accordance with the preferred embodiment of the present invention comprises a drive shaft 20, a plurality of support frames 21 mounted on the drive shaft 20 to rotate the drive shaft 20, and a plurality of blades 22 each pivotally mounted on a respective one of the support frames 21.

The drive shaft 20 is disposed at an upright state and is mounted on a generating device 30.

Each of the support frames 21 has a substantially rectangular shape and is disposed at an upright state. Each of the support frames 21 includes two crossbars 210 each connected with the drive shaft 20 to rotate the drive shaft 20 and an upright support bar 212 mounted between the two crossbars 210. The two crossbars 210 of each of the support frames 21 are located between the upright support bar 212 and the drive shaft 20.

Each of the blades 22 is movable and pivotable relative to the drive shaft 20. Each of the blades 22 is disposed between the two crossbars 210 and the upright support bar 212 of the respective support frame 21. Each of the blades 22 has a first end 220 pivotally mounted on the respective support frame 21 and a second end 222 that is movable to abut the drive shaft 20. The first end 220 of each of the blades 22 is pivotally mounted on the upright support bar 212 of the respective support frame 21. Each of the blades 22 is a sheet plate and has a width greater than that of the respective support frame 21 and greater than a length of each of the two crossbars 210 of the respective support frame 21.

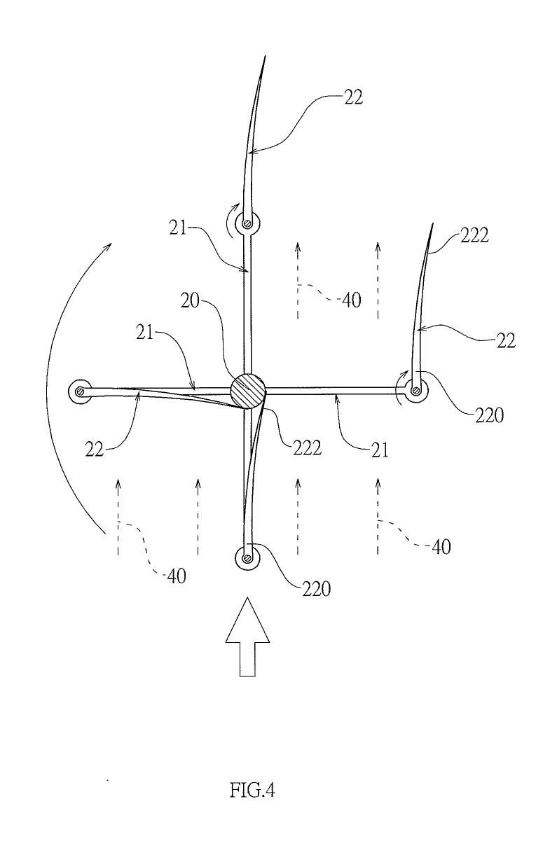

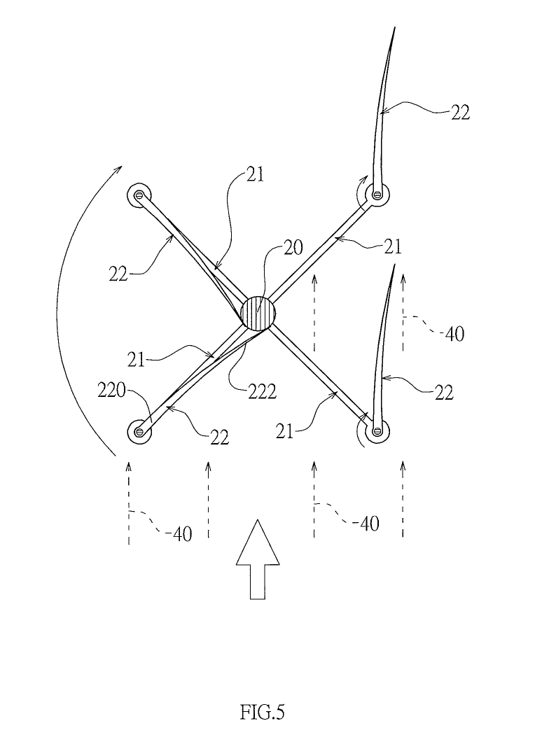

In operation, referring to FIGS. 4 and 5 with reference to FIG. 3, when a power 40, such as the wind power or water power, touches the blades 22, the blades 22 are pushed to pivot about the support frames 21 respectively so that some of the blades 22 are moved to abut the drive shaft 20, and some of the blades 22 are moved to space from the drive shaft 20 and to be parallel with the travel direction of the power 40. In such a manner, the blades 22 that are moved to abut the drive shaft 20 will be pushed by the power 40 to drive and rotate the drive shaft 20 so as to drive the generating device 30 to provide a generating function, while the blades 22 that are moved to be parallel with the power 40 are directed to the direction of the power 40 and will not produce a drag or resistance to the power 40 so as to facilitate rotation of the drive shaft 20 and to enhance the generating efficiency.

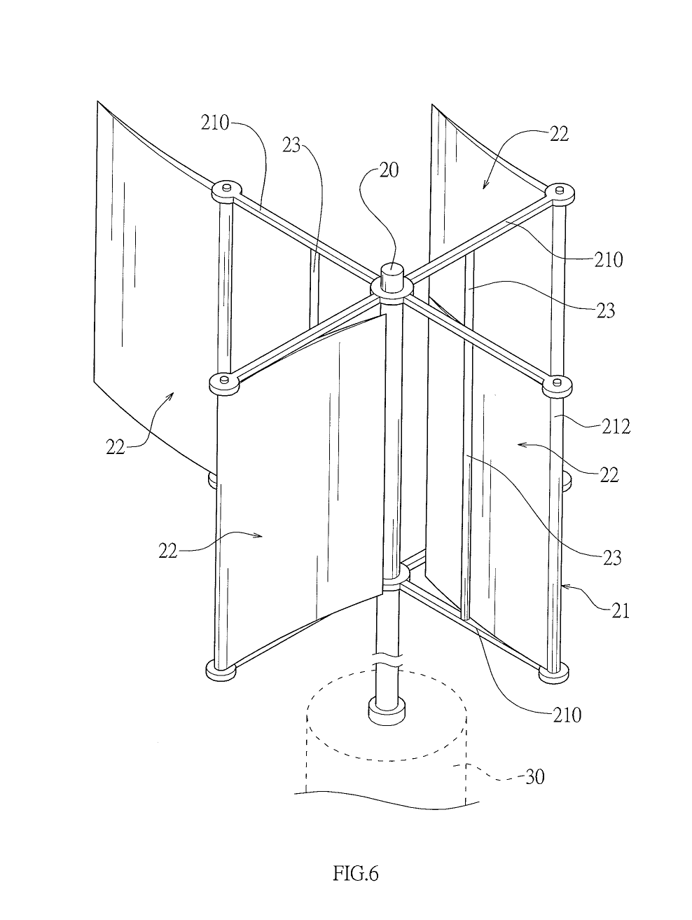

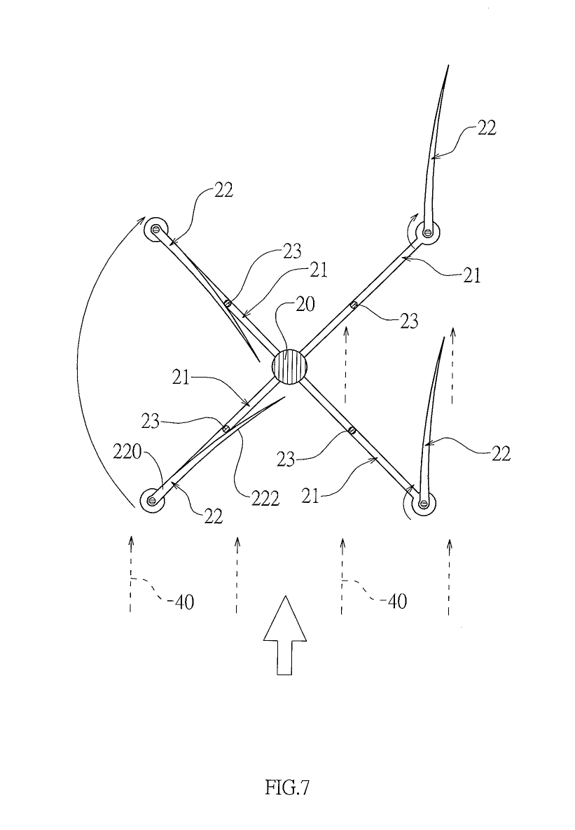

Referring to FIGS. 6 and 7, each of the support frames 21 further includes a limit rod 23 mounted between the two crossbars 210 to limit each of the blades 22. The limit rod 23 of each of the support frames 21 is disposed at an upright state and has two opposite ends connected with the two crossbars 210 respectively. The limit rod 23 of each of the support frames 21 is disposed between and spaced from the upright support bar 212 and the drive shaft 20. Each of the blades 22 is movable to abut the limit rod 23 of the respective support frame 21 with the limit rod 23 being located between the first end 220 and the second end 222 of each of the blades 22 so that each of the blades 22 is supported by the limit rod 23 of the respective support frame 21 solidly and stably.

In operation, when the power 40 touches the blades 22, the blades 22 are pushed to pivot about the support frames 21 respectively so that some of the blades 22 are moved to abut the limit rods 23 of the respective support frames 21, and some of the blades 22 are moved to space from the limit rods 23 of the respective support frames 21 and to be parallel with the travel direction of the power 40. In such a manner, the blades 22 that are moved to abut the limit rods 23 of the respective support frames 21 will be pushed by the power 40 to drive and rotate the drive shaft 20 so as to drive the generating device 30 to provide a generating function, while the blades 22 that are moved to be parallel with the power 40 are directed to the direction of the power 40 and will not produce a drag or resistance to the power 40 so as to facilitate rotation of the drive shaft 20 and to enhance the generating efficiency.

Accordingly, the blades 22 are pivotally mounted on the support frames 21 and are pivotable relative to the drive shaft 20 so that when the power 40 touches the blades 22, the blades 22 are pushed to pivot toward the travel direction of the power 40 such that some of the blades 22 are moved to abut the drive shaft 20 and some of the blades 22 are moved to space from the drive shaft 20 and to be parallel with the travel direction of the power 40. In addition, the blades 22 that are moved to abut the drive shaft 20 will be pushed by the power 40 to drive and rotate the drive shaft 20 so as to drive the generating device 30 to provide a generating function, while the blades 22 that are moved to be parallel with the power 40 are directed toward the travel direction of the power 40 and will not produce a drag or resistance to the power 40 so as to facilitate rotation of the drive shaft 20 and to enhance the generating efficiency. Further, each of the blades 22 is movable to abut the limit rod 23 of the respective support frame 21 so that each of the blades 22 is supported by the limit rod 23 of the respective support frame 21 solidly and stably.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A rotor, comprising:
a drive shaft;
a plurality of support frames mounted on the drive shaft to rotate the drive shaft; and
a plurality of blades each pivotally mounted on a respective one of the support frames.

2. The rotor of claim 1, wherein each of the support frames includes:
two crossbars each connected with the drive shaft to rotate the drive shaft; and
an upright support bar mounted between the two crossbars.

3. The rotor of claim 2, wherein
each of the blades has a first end pivotally mounted on the respective support frame and a second end that is movable to abut the drive shaft;
the first end of each of the blades is pivotally mounted on the upright support bar of the respective support frame.

4. The rotor of claim 2, wherein the two crossbars of each of the support frames are located between the upright support bar and the drive shaft.

5. The rotor of claim 2, wherein each of the blades is disposed between the two crossbars and the upright support bar of the respective support frame.

6. The rotor of claim 1, wherein each of the blades is movable and pivotable relative to the drive shaft.

7. The rotor of claim 1, wherein each of the blades is a sheet plate.

8. The rotor of claim 1, wherein each of the blades has a width greater than that of the respective support frame.

9. The rotor of claim 3, wherein each of the blades has a width greater than a length of each of the two crossbars of the respective support frame.

10. The rotor of claim 1, wherein
some of the blades are movable to abut the drive shaft;
some of the blades are movable to space from the drive shaft and to be parallel with a direction of a power.

11. The rotor of claim 2, wherein each of the support frames has a substantially rectangular shape.

12. The rotor of claim 2, wherein each of the support frames further includes a limit rod mounted between the two crossbars to limit each of the blades.

13. The rotor of claim 12, wherein the limit rod of each of the support frames is disposed at an upright state and has two opposite ends connected with the two crossbars respectively.

14. The rotor of claim 12, wherein the limit rod of each of the support frames is disposed between and spaced from the upright support bar and the drive shaft.

15. The rotor of claim 12, wherein each of the blades is movable to abut the limit rod of the respective support frame with the limit rod being located between a first end and a second end of each of the blades.
